(19) United States
(12) Patent Application Publication
(10) Pub. No.: US 2026/0019830 A1
(43) Pub. Date: Jan. 15, 2026

(54) BASE STATION, RADIO TERMINAL, AND METHODS THEREFOR

(71) Applicant: NEC Corporation, Minato-ku, Tokyo (JP)

(72) Inventors: Kazushi MURAOKA, Tokyo (JP); Toshiki TAKEUCHI, Tokyo (JP); Yasushi MARUTA, Tokyo (JP)

(73) Assignee: NEC Corporation, Minato-ku, Tokyo (JP)

(21) Appl. No.: 18/996,002

(22) PCT Filed: Jul. 31, 2023
(86) PCT No.: PCT/JP2023/027986

§ 371 Date: Jan. 17, 2025

(30) Foreign Application Priority Data
Sep. 9, 2022 (JP) 2022-143673

(51) Int. Cl. H04W 16/28; H04W 72/23

(52) U.S. Cl. CPC H04W 16/28; H04W 72/23

(57) ABSTRACT

A radio terminal receives, via a signal, physical channel, or message to be received by at least a plurality of radio terminals in an idle mode, a first indication indicating a number of transmission points that can be or are being used in a cell. For example, this can help to enable radio terminals to be aware of the number of transmission points that can be or are being used in a cell, or the number of beams that can be or are being transmitted simultaneously in the same time and frequency resources in a cell.

### TECHNICAL FIELD

The present disclosure relates to a wireless communication system, in particular, to a beam sweep transmission of a broadcast signal by a base station.

### BACKGROUND ART

3rd Generation Partnership Project (3GPP (registered trademark)) Fifth Generation (5G) systems use beam sweeping to allow a User Equipment (UE) to select the best beam during initial access. Specifically, a gNB transmits multiple Synchronization Signal (SS)/Physical Broadcast Channel (PBCH) blocks (SSBs) as a burst, changing the beam direction each time an SSB is transmitted at a fixed periodicity. Each SSB contains a Primary Synchronization Signal (PSS), a Secondary Synchronization Signal (SSS), a PBCH, and PBCH Demodulation Reference Signals (DMRS).

A single SSB is spread over four consecutive Orthogonal Frequency Division Multiplexing (OFDM) symbols in the time domain and 240 consecutive subcarriers (i.e., 20 resource blocks) in the frequency domain. SSBs within a burst correspond to individual beams and are beam-formed in different directions. A set of SSBs within a burst is called an SSB burst set and is transmitted in a half radio frame, a window of 5 milliseconds (ms). An SSB burst set (i.e., 5 ms duration) is typically repeated at a periodicity of 2 radio frames, or 20 ms. In order to achieve a trade-off between coverage and resource overhead, the maximum number of SSBs within an SSB burst set (i.e., 5 ms duration) is defined as 4 for frequency bands up to 3 GHZ, 8 for 3 to 6 GHZ, and 64 for 6 to 52.6 GHz. The number of SSBs actually transmitted within a cell is configurable and may be less than the maximum.

Each SSB within a single SSB burst set (5 ms) is assigned a unique SSB index numbered from 0 increasing by 1. If the maximum number of candidate SSBs that can be transmitted within an SSB burst set is 64, the SSB index is communicated to the UE via two parts within an SSB. The SSB index is divided into two fields, with the first field transmitted as part of the PBCH payload and the second part of the SSB index transmitted as part of the PBCH DMRS sequence.

In a case where a UE synchronizes with a wireless access network and performs an initial access, it is required to read an SSB. In the idle state or mode, i.e., Radio Resource Control (RRC)_IDLE or RRC_INACTIVE, the UE searches for SSBs being transmitted in a cell, receives an SSB burst set, and selects an SSB with the best reception quality, i.e., the best beam. The SSB indexes are mapped to available Random Access Channel (RACH) occasions. The UE notifies the network, i.e., a gNB, of the SSB beam selected by the UE by transmitting a Physical RACH (PRACH) preamble on the RACH occasion associated with the selected best beam.

For example, the 5G specifications for SSB beam sweeping provided by 3GPP can be found in Non-Patent Literature 1-4.

### CITATION LIST

### Non Patent Literature

[Non-Patent Literature 1] 3GPP TS 38.211 V17.2.0 (2022-06), “3rd Generation Partnership Project: Technical Specification Group Radio Access Network: NR: Physical channels and modulation (Release 17)”, June 2022
[Non-Patent Literature 2] 3GPP TS 38.212 V17.2.0 (2022-06), “3rd Generation Partnership Project: Technical Specification Group Radio Access Network: NR: Multiplexing and channel coding (Release 17)”, June 2022
[Non-Patent Literature 3] 3GPP TS 38.213 V17.2.0 (2022-06), “3rd Generation Partnership Project: Technical Specification Group Radio Access Network: NR: Physical layer procedures for control (Release 17)”, June 2022
[Non-Patent Literature 4] 3GPP TS 38.331 V17.1.0 (2022-06), “3rd Generation Partnership Project: Technical Specification Group Radio Access Network: NR: Radio Resource Control (RRC) protocol specification (Release 17)”, July 2022.

### SUMMARY OF INVENTION

### Technical Problem

The inventors anticipate that 5G system enhancements, or future 6G or later systems, will use millimeter-wave or sub-terahertz frequencies and employ a deployment of multiple Transmission Reception Points (TRPs) that are geographically dispersed and have overlapping coverage areas to achieve site diversity effects. A TRP hosts one or more antenna elements (typically an array antenna) and radio frequency (RF) components, and can communicate with UEs using beams. A TRP may also be referred to as a radio unit (RU), remote radio head (RRH), access point, or distributed antenna. In a case where only downlink transmissions (e.g., SSB transmission) from a base station are considered, a TRP may also be referred to as a transmission point.

However, if a large number of TRPs are used in a single cell and the number of beams transmitted within that cell increases, the current maximum number of candidate SSB beams of 64 may not be sufficient. If all of the SSB beams transmitted in a cell are swept with different time resources or OFDM symbols, then the current constraints on either or both the SSB burst periodicity (i.e., 20 ms) and the SSB burst duration (i.e., 5 ms) may need to be relaxed in order to increase the maximum number of candidate SSB beams to beyond 64. Specifically, it may be necessary to shorten the SSB burst periodicity or lengthen the duration of the SSB burst set, or both. These would increase the overhead of SSB transmission (i.e., beam sweep transmission).

A UE searches for the strongest cell in each frequency (or each frequency band). The UE determines whether the strongest cell meets a cell selection criterion in addition to other conditions in order to determine a suitable cell on which the UE may camp. In cell selection for multi-beam operation, the measurement quantity of the cell depends on the UE implementation. In other words, in cell selection for multi-beam operation, how the UE derives the cell measurement quantity depends on the UE implementation.

In some implementations, before decoding the System Information Block Type 1 (SIB1), the UE may attempt to receive multiple SSBs (i.e., multiple SSB beams) transmitted in the cell and derive the cell measurement quantity as the highest beam measurement quantity value. Each beam measurement quantity may be Synchronization Signal (SS) reference signal received power (SS-RSRP), SS reference signal received quality (SS-RSRQ), or SS signal-to-noise and interference ratio (SS-SINR). Such an implementation will require the UE is required to attempt to receive SSBs at a large number of candidate time domain locations before knowing from the information in the decoded SIB1 which candidate time domain locations in the SSB burst set the SSBs are being transmitted. This will result in an increase in the power consumption of the UE.

In order to suppress the increase in power consumption of the UE, it is preferable for the UE to be able to know the time domain locations where SSBs are being transmitted within an SSB burst set, or for the UE to be able to narrow down the candidate time domain locations where SSB reception should be attempted within an SSB burst set. By way of example, but not limitation, the number of TRPs that can be or are used in a cell can be associated with the number and arrangement of candidate time domain locations where SSBs can be transmitted in the cell. In other words, the number and arrangement of candidate time domain locations where SSBs may be transmitted within a cell may depend on the number of TPRs used within the cell.

In addition, if the maximum number of SSBs (SSB beams) that can be transmitted within a cell is increased to a sufficiently large number, the total size of one or more bitmaps for specifying the SSBs actually used may become large. One approach to address this issue is to impose a constraint on the rules for using candidate time domain locations within an SSB burst set that depends on the number of TRPs used within the cell.

Alternatively, an architecture could be adopted that allows multiple TRPs to transmit SSB beams simultaneously in the same time resource or OFDM symbol in order to reduce the overhead of SSB transmission. This will reduce the amount of radio resources required to transmit different SSB beams, thus helping to reduce the overhead of SSB transmission (i.e., beam sweep transmission). Specifically, multiple TRPs may transmit the same set or different sets of PBCH modulation symbols generated from the same PBCH payload or different PBCH payloads using the same time and frequency resources, i.e., resource elements. However, this architecture may make it difficult for the UE to measure the received power or quality of each SSB beam due to interference between SSB beams.

To address this issue, it may be effective to transmit a TRP-specific or dedicated PBCH DMRS in time and frequency resources (i.e., resource elements) individually assigned to each TRP. By way of example, but not limitation, the arrangement or pattern of resources in which TRP-specific PBCH DMRS is transmitted may depend on the number of TRPs used in the cell. Alternatively, the arrangement or pattern of resources in which TRP-specific PBCH DMRS is transmitted may depend on the number of SSBs (or SSB beams) being transmitted simultaneously in the same time and frequency resources within the cell.

To help address some of the issues mentioned above, it may be effective to allow UEs to be aware of the number of TRPs (or transmission points) that can be used or are being used within a cell. Alternatively, it may be effective to allow UEs to be aware of the number of beams that can be transmitted or are being transmitted simultaneously in the same time and frequency resources in a cell. More specifically, it may be useful to allow UEs in an idle state or mode (e.g., RRC_IDLE or RRC_INACTIVE or both) to know the number of such transmission points or beams.

One of the objects to be achieved by the example embodiments disclosed herein seek to achieve is to provide apparatuses, methods, and programs that enable UEs or radio terminals to be aware of the number of transmission points that can be used or are being used in a cell, or the number of beams that can be transmitted or are being transmitted simultaneously in the same time and frequency resources in a cell. It should be noted that this object is only one of the objects to be achieved by the example embodiments disclosed herein. Other objects or problems and novel features will become apparent from the following description and the accompanying drawings.

### Solution to Problem

In a first aspect, a base station includes at least one memory and at least one processor coupled to the at least one memory. The at least one processor is configured to transmit within a cell, using a signal, physical channel, or message to be received by at least a plurality of radio terminals in an idle mode, a first indication indicating a number of transmission points that can be or are being used in the cell.

In a second aspect, a method performed by a base station includes transmitting within a cell, using a signal, physical channel, or message to be received by at least a plurality of radio terminals in an idle mode, a first indication indicating a number of transmission points that can be or are being used in the cell.

In a third aspect, a radio terminal includes at least one memory and at least one processor coupled to the at least one memory. The at least one processor is configured to receive, via a signal, physical channel, or message to be received by at least a plurality of radio terminals in an idle mode, a first indication indicating a number of transmission points that can be or are being used in a cell.

In a fourth aspect, a method performed by a radio terminal includes receiving, via a signal, physical channel, or message to be received by at least a plurality of radio terminals in an idle mode, a first indication indicating a number of transmission points that can be or are being used in a cell.

In a fifth aspect, a base station includes at least one memory and at least one processor coupled to the at least one memory. The at least one processor is configured to transmit, via a signal or physical channel within an SSB, a first indication indicating a number of one or more subsets of a plurality of subsets of candidate time domain locations within an SSB burst set that are potentially used or are being used.

In a sixth aspect, a method performed by a base station includes transmitting, via a signal or physical channel within an SSB, a first indication indicating a number of one or more subsets of a plurality of subsets of candidate time domain locations within an SSB burst set that are potentially used or are being used.

In a seventh aspect, a radio terminal includes at least one memory and at least one processor coupled to the at least one memory. The at least one processor is configured to receive, via a signal or physical channel within an SSB, a first indication indicating a number of one or more subsets of a plurality of subsets of candidate time domain locations within an SSB burst set that are potentially used or are being used.

In an eighth aspect, a method performed by a radio terminal includes receiving, via a signal or physical channel within an SSB, a first indication indicating a number of one or more subsets of a plurality of subsets of candidate time domain locations within an SSB burst set that are potentially used or are being used.

In a ninth aspect, a base station includes at least one memory and at least one processor coupled to the at least one memory. The at least one processor is configured to transmit within a cell, using a signal, physical channel, or message to be received by at least a plurality of radio terminals in an idle mode, a first indication indicating a number of beams that can be transmitted or are being transmitted in same time and frequency resources in the cell.

In a tenth aspect, a method performed by a base station includes transmitting within a cell, using a signal, physical channel, or message to be received by at least a plurality of radio terminals in an idle mode, a first indication indicating a number of beams that can be transmitted or are being transmitted in same time and frequency resources in the cell.

In an eleventh aspect, a radio terminal includes at least one memory and at least one processor coupled to the at least one memory. The at least one processor is configured to receive, via a signal, physical channel, or message to be received by at least a plurality of radio terminals in an idle mode, a first indication indicating a number of beams that can be transmitted or are being transmitted in same time and frequency resources in a cell.

In a twelfth aspect, a method performed by a radio terminal includes receiving, via a signal, physical channel, or message to be received by at least a plurality of radio terminals in an idle mode, a first indication indicating a number of beams that can be transmitted or are being transmitted in same time and frequency resources in a cell.

A thirteenth aspect is directed to a program. The program includes a set of instructions (software code) that, when loaded into a computer, cause the computer to perform the method according to the second, fourth, sixth, eighth, tenth, or twelfth aspect described above.

### Advantageous Effects of Invention

According to the aspects described above, it is possible to provide apparatuses, methods, and programs that enable UEs or radio terminals to be aware of the number of transmission points that can be used or are being used in a cell, or the number of beams that can be transmitted or are being transmitted simultaneously in the same time and frequency resources in a cell.

### BRIEF DESCRIPTION OF DRAWINGS

FIG. 1 shows an example configuration of a radio communication system in an example embodiment;

FIG. 2 shows an example configuration of a transmission system of a base station in an example embodiment:

FIG. 3 shows an example configuration of a transmission system of a base station in an example embodiment:

FIG. 4 is a sequence diagram showing an example of signaling between a base station and a UE in an example embodiment:

FIG. 5 is a flowchart showing an example of the operation of a UE in an example embodiment:

FIG. 6 is a diagram to explain an example of SSB reception operation by a UE in an example embodiment:

FIG. 7 is a sequence diagram showing an example of signaling between a base station and a UE in an example embodiment:

FIG. 8 is a flowchart showing an example of the operation of a UE in an example embodiment:

FIG. 9 is a diagram to explain an example of transmission of multiple SSBs in an example embodiment:

FIG. 10 is a diagram to explain an example of transmission of multiple SSBs in an example embodiment:

FIG. 11 is a sequence diagram showing an example of signaling between a base station and a UE in an example embodiment:

FIG. 12 is a flowchart showing an example of the operation of a UE in an example embodiment:

FIG. 13 is a flowchart showing an example of the operation of a UE in an example embodiment:

FIG. 14 is a diagram to explain an example of transmission of multiple SSBs in an example embodiment:

FIG. 15 shows an example of the mapping of TRP-specific PBCH DMRS in an SSB in an example embodiment:

FIG. 16 is a sequence diagram showing an example of signaling between a base station and a UE in an example embodiment:

FIG. 17 is a flowchart showing an example of the operation of a UE in an example embodiment;

FIG. 18 is a block diagram showing an example configuration of a CU and a DU in an example embodiment:

FIG. 19 is a block diagram showing an example configuration of a TRP in an example embodiment; and

FIG. 20 is a block diagram showing an example configuration of a UE in an example embodiment.

### EXAMPLE EMBODIMENT

Specific example embodiments will be described hereinafter in detail with reference to the drawings. Identical or corresponding elements are designated by the same symbols throughout the drawings, and duplicate explanations are omitted where necessary for the sake of clarity.

The multiple example embodiments described below may be implemented independently or in any suitable combination. These multiple example embodiments have novel features that differ from one another. Accordingly, these multiple example embodiments contribute to achieving different objectives or solving different problems and contribute to achieving different advantages.

The following example embodiments are described primarily with respect to 3GPP 5G systems. However, these embodiments can also be applied to other radio communication systems that support beam sweeping techniques similar to SSB beam sweeping in 3GPP 5G systems.

As used in this specification, “if” can be interpreted to mean “when”, “at or around the time”, “after”, “upon”, “in response to determining”, “in accordance with a determination”, or “in response to detecting”, depending on the context. These expressions can be interpreted to mean the same thing, depending on the context.

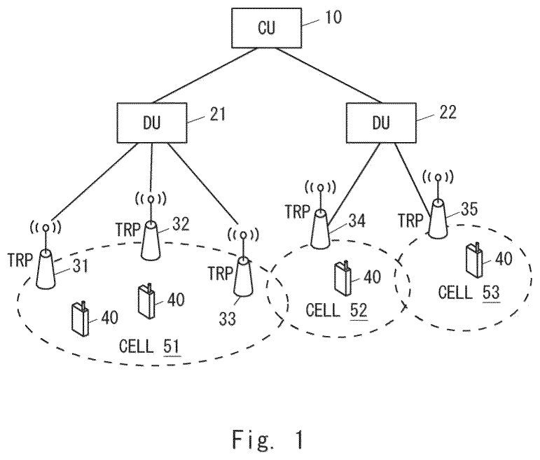

First, the configuration and operation of a plurality of network elements common to a plurality of example embodiments are described. FIG. 1 shows an example configuration of a radio communication system according to a plurality of example embodiments. In the example of FIG. 1, the radio communication system includes a Central Unit (CU) 10, Distributed Units (DUs) 21 and 22, TRPs 31 to 35, and UEs 40. The UEs 40 may also be referred to by other terms such as radio terminals, mobile terminals, mobile stations, or wireless transmit receive units (WTRUs). Each element (or network function) shown in FIG. 1 can be implemented, for example, as a network element on dedicated hardware, as a software instance running on dedicated hardware, or as a virtualized function instantiated on an application platform.

The CU 10, the DUs 21 and 22, and the TRPs 31 to 35 correspond to a single base station. In other words, a single base station includes the CU 10, the DUs 21 and 22, and the TRPs 31 to 35. A base station may be referred to as a radio access network node, a radio station, or an access point. In the case of a 5G system, a base station may be a gNB.

The CU 10 may host the RRC, Service Data Adaptation Protocol (SDAP), and Packet Data Convergence Protocol (PDCP) protocols of a gNB (or the RRC and PDCP protocols of a gNB). The CU 10 may contain a Control Plane (CP) unit (e.g., gNB-CU-CP) and one or more User Plane (UP) units (e.g., gNB-CU-UPs).

Each of the DUs 21 and 22 hosts the Radio Link Control (RLC) and Medium Access Control (MAC) layers of a gNB, and may also host part or all of the Physical (PHY) layer of a gNB. In cases where each of the DUs 21 and 22 hosts a part of the PHY layer, namely the high PHY layer, the remaining PHY layer signal processing, namely the low PHY layer, is placed in the TRPs 31 to 35. In the example shown in FIG. 1, the DU 21 is connected to the TRPs 31 to 33, while the DU 22 is connected to the TRPs 34 and 35. The TRPs 31 to 33 provide a single cell 51, while the TRPs 34 and 35 provide different cells 52 and 53, respectively. In other words, the DU 21 provides a single cell 51, and the TRPs 31 to 33 correspond to the cell 51. The DU 22 provides multiple cells 52 and 53, and the TRPs 34 and 35 correspond to the cells 52 and 53, respectively.

Each of the TRPs 31 to 35 can communicate with the UEs 40 using beams. The TRPs 31 to 35 may be referred to as Radio Units (RUS), Remote Radio Heads (RRHs), access points (APs), or distributed antennas. In a case where only downlink transmission (e.g., SSB transmission) by the base station is considered, each TRP may be referred to as a transmission point.

Each of the TRPs 31 to 35 provides analog RF signal processing. Each TRP may provide low PHY layer signal processing. Each TRP includes or is connected to one or more antenna elements (typically an array antenna). Each TRP includes RF components coupled to one or more antenna elements. For analog or hybrid beamforming, analog beamforming circuitry may be placed between one or more antenna elements or one or more array antennas and a plurality of RF chains of each TRP.

Each TRP may also include a digital front end (DFE). The DFE provides low PHY layer signal processing and digital radio signal processing. The low PHY signal processing includes, for example, inverse fast Fourier transform (IFFT) for OFDM signal generation and FFT for obtaining subcarrier signal components from received OFDM signals. The low PHY layer signal processing may also include Cyclic Prefix (CP) addition and removal, and may include Physical RACH (PRACH) extraction or filtering. The digital radio signal processing may include, for example, digital pre-distortion (DPD), crest factor reduction (CFR), digital up conversion (DUC), digital down conversion (DDC), and transmit/receive baseband channel filter. The DFE may perform digital baseband precoding for beamforming.

The DU 21 may be connected to each of the TRPs 31 to 33 via an interface that conforms to standard specifications such as the Common Public Radio Interface (CPRI), enhanced CPRI (eCPRI), and Open Radio Access Network (O-RAN) Fronthaul. Alternatively, the DU 21 may be connected to each of the TRPs 31 to 33 via an interface using Radio over Fiber (RoF) technology. In this case, the DU 21 may perform all digital signal processing, including high PHY layer and low PHY layer signal processing, as well as digital-to-analog (DA) and analog-to-digital (AD) conversion.

A direct interface, connection or backhaul may be provided to communicatively connect the DU 21 and the DU 22. Similarly, a direct interface, connection, or backhaul may be provided to communicatively connect TRPs within a cell or between cells, such as between TRPs 31 to 33, between TRPs 33 and 34, and between TRPs 34 and 35.

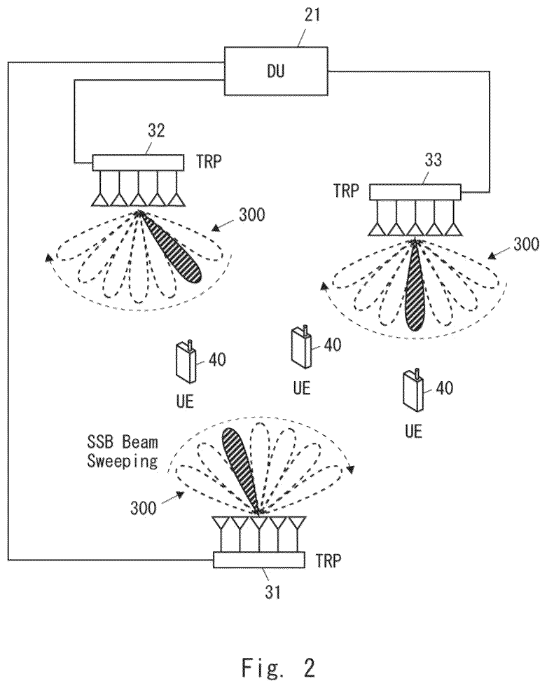

FIG. 2 conceptually shows the SSB beam sweep performed by the TRPs 31 to 33 in a single cell (cell 51). To allow UEs 40 to select the best beam for initial access, each of the TRPs 31 to 33 uses a beam sweep 300. Specifically, each TRP transmits multiple SSBs, changing the beam direction each time it transmits an SSB. Each SSB contains a PSS, an SSS, a PBCH, and PBCH DMRS. In a case where multiple TRPs are arranged in a single cell, at least one of these TRPs may transmit only one SSB beam. In other words, at least one of the multiple TRPs in the cell may intermittently transmit one SSB beam in a predetermined direction at a predetermined cycle without performing a beam sweep.

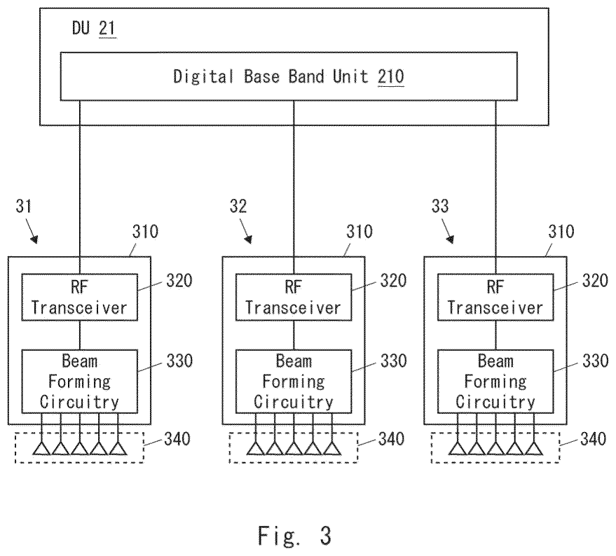

FIG. 3 shows an example configuration of the DU 21 and the TRPs 31 to 33 providing a single cell (cell 51). In the example shown in FIG. 3, the DU 21 includes a digital baseband unit 210. The digital baseband unit 210 provides signal processing for the RLC, MAC, and high PHY layers. With respect to SSB transmission, the digital baseband unit 210 generates a Broadcast Channel (BCH) transport block containing a Master Information Block (MIB) message, and then generates a PBCH payload containing that BCH transport block and additional timing-related PBCH payload bits. The digital baseband unit 210 also performs scrambling, cyclic redundancy check (CRC) bit addition, channel coding, and rate matching on the generated PBCH payload. Further, the digital baseband unit 210 performs scrambling on the block of bits after rate matching and maps the scrambled block of bits to multiple modulation symbols (e.g., complex-valued Quadrature Phase Shift Keying (QPSK) symbols).

Depending on the functional split between the DU 21 and the TRPs 31 to 33, the digital baseband unit 210 may perform all the digital signal processing, including the low PHY layer signal processing, as well as digital-to-analog (DA) and analog-to-digital (AD) conversion.

In the example shown in FIG. 3, each of the TRPs 31 to 33 includes an RF component 310. The RF component 310 is coupled to an antenna 340. In the example shown in FIG. 3, the antenna 340 includes a plurality of antenna elements and is typically an array antenna. The RF component 310 includes an RF transceiver 320 and beamforming circuitry 330. The RF transceiver 320 includes an amplifier and a frequency converter. The beamforming circuitry 330 determines the beam direction by adjusting one or both of the phase and the amplitude of the radio signal to be fed to the multiple antenna elements of the antenna 340. The specific beam direction or beam number, etc., is specified by the DU 21 or the CU 10. Other beamforming techniques may be used, and the antenna 340 may be a directional antenna, such as a lens antenna or a metamaterial antenna.

### First Example Embodiment

An example configuration of a radio communication system in this example embodiment may be the same as the example explained with reference to FIGS. 1 to 3. This example embodiment provides the operation of a base station and a UE with respect to beam sweep transmission and reception of SSBs.

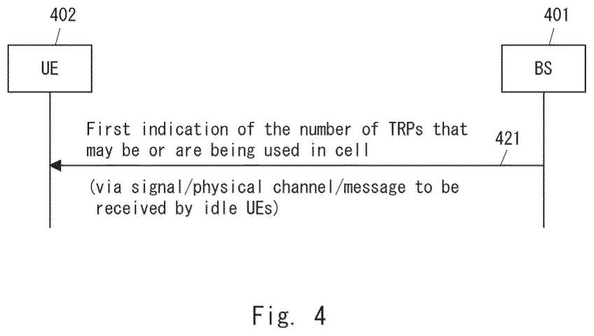

FIG. 4 shows an example of signaling between a base station and a UE. The base station (BS) 401 in FIG. 4 may be the CU 10 or the DU 21 as explained with reference to FIGS. 1 to 3. The UE 402 in FIG. 4 may be the UE 40 as explained with reference to FIGS. 1 to 3.

In step 421, the base station (BS) 401 transmits in a cell a first indication indicating the number of TRPs (or transmission points) that can be or are being used in the cell, using a signal, physical channel, or message to be received by at least a plurality of UEs in an idle state or mode. The UE 402, which is in the idle state or mode, receives the first indication. The idle state or mode may be RRC_IDLE or RRC_INACTIVE. The first indication of the number of TRPs (or transmission points) may be referred to as information, data, a configuration, or configuration information indicating the number of TRPs (or transmission points).

The base station 401 may transmit the first indication using a signal or physical channel included in an SSB. Alternatively, the base station 401 may transmit the first indication using SIB1. The base station 401 may transmit the first indication using another SIB. The first indication may be divided into multiple fields and transmitted over multiple signals or physical channels.

In one implementation, the base station 401 may provide the first indication to the UE 402 using at least the sequence of a synchronization signal transmitted within the SSB, i.e., the PSS or the SSS. Additionally or alternatively, the base station 401 may provide the first indication to the UE 402 using at least the sequence of a PBCH DMRS transmitted within the SSB. The PBCH DMRS is used by the UE 402 to demodulate PBCH modulation symbols generated from a PBCH payload. Additionally or alternatively, the base station 401 may provide the first indication to the UE 402 using at least the PBCH payload (e.g., MIB).

According to the operation described with reference to FIG. 4, the base station 401 can enable the UE 402 to be aware of the number of TRPs (or transmission points) that can be or are being used in a cell. Details of the various uses of the first indication by the UE 402, and details of the timing of transmission of the first indication suitable for those uses, are explained in detail in the following example embodiments.

### Second Example Embodiment

An example configuration of a radio communication system in this example embodiment may be the same as the example explained with reference to FIGS. 1 to 3. This example embodiment provides details of the operation of the base station and the UE with respect to the signaling indicating the number of TRPs described in the first example embodiment.

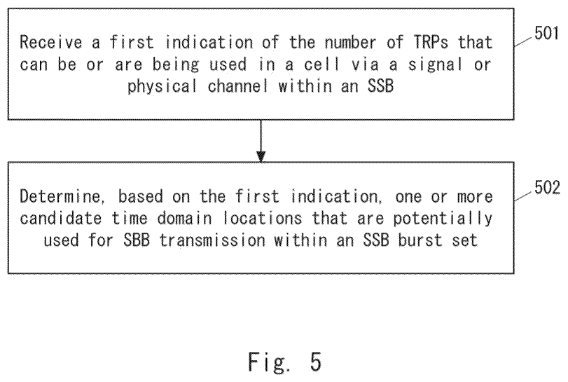

FIG. 5 shows an example of the operation of a UE (e.g., UE 40). In step 501, the UE receives, via a signal or physical channel within an SSB, a first indication indicating the number of TRPs (or transmission points) that can be or are being used in a cell. A base station may provide the first indication to the UE using at least the sequence of a synchronization signal transmitted within the SSB, i.e., the PSS or the SSS. Additionally or alternatively, the base station may provide the first indication to the UE using at least the sequence of a PBCH DMRS transmitted within the SSB. The PBCH DMRS is used by the UE to demodulate PBCH modulation symbols generated from a PBCH payload. Additionally or alternatively, the base station may provide the first indication to the UE using at least the PBCH payload (e.g., MIB).

In step 502, based on the first indication, the UE determines one or more candidate time domain locations that are potentially used for SSB transmission within an SSB burst set. To achieve this, a constraint is imposed on the rules for the base station to use candidate time domain locations within an SSB burst set, depending on the number of TRPs used in the cell. Each time domain location is a position in the time domain in the mapping of time and frequency resources (resource elements). The candidate time domain positions (or locations) within an SSB burst set can also be referred to as the transmission occasions of SSBs within an SSB burst set. In one example, the multiple candidate time domain locations within an SSB burst set may be divided into multiple subsets, and each subset may be associated with a given number of TRP(s). The given number may be one or more. The number of divided subsets may define the maximum number of TRPs available in the cell. Based on the number of TRPs indicated by the first indication, the UE may determine which subset(s) of the divided subset are used for SSB transmission. Each subset may be consecutive candidate time domain locations within the SSB burst set.

Alternatively, each subset may be composed of multiple candidate time domain locations that are discrete within the SSB burst set.

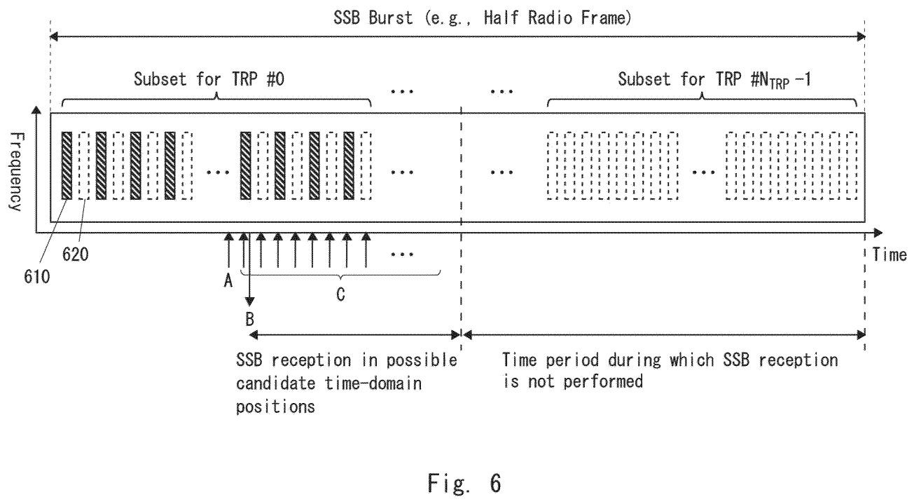

FIG. 6 shows an example of SSB reception operation by the UE. In the example shown in FIG. 6, the candidate time domain locations within a single SSB burst set are divided into N_{TRP} subsets. N_{TRP} is the maximum number of TRPs in a single cell. The base station transmits the first indication, which indicates a value between 1 and N_{TRP} in a signal or physical channel within an SSB. The first indication specifies the number of TRPs that can be or are being used in the cell. For example, the base station uses the same number of subsets as the number of TRPs specified in the first indication, sequentially from the beginning of the SSB burst set. At the candidate time domain locations (610) indicated by the shaded areas in FIG. 6, SSBs are transmitted. On the other hand, SSBs are not transmitted at the candidate time domain locations (620) that are not shaded in FIG. 6. As an example, but not a limitation, the duration of the SSB burst set can be the same as that of the current NR specification, i.e., half a radio frame, or 5 ms.

The UE switches on at timing A shown in FIG. 6 and searches for an SSB. If the UE receives an SSB, it acquires the first indication at timing B shown in FIG. 6. The first indication shows the number of TRPs that can be or are being used in the cell. This allows the UE to know the number of subsets in which SSBs are being transmitted. In addition, the UE detects the SSB index from the received SSB. The SSB index is associated with the candidate time domain location (and subset) in which the SSB is transmitted. This allows the UE to determine the candidate time domain locations in which SSBs are potentially transmitted. The UE may attempt SSB reception at possible candidate time domain locations (period C shown in FIG. 6) and stop SSB reception at other candidate time domain locations. Such behavior can help reduce the increase in power consumption of the UE.

### Third Example Embodiment

An example configuration of a radio communication system in this example embodiment may be the same as the example explained with reference to FIGS. 1 to 3. This example embodiment provides details of the operation of the base station and the UE with respect to the signaling indicating the number of TRPs described in the first and second example embodiments. More specifically, this example embodiment provides a method for reducing the amount of information or the number of bits required to indicate to UEs the candidate time domain locations in which SSBs are actually being transmitted.

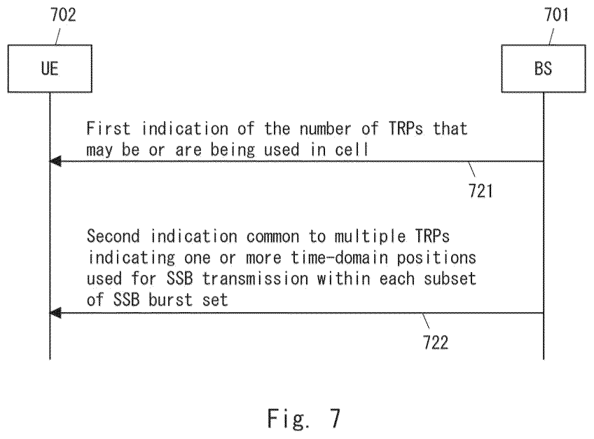

FIG. 7 shows an example of signalling between a base station and a UE. The base station 701 in FIG. 7 may be the CU 10 or the DU 21 as explained with reference to FIGS. 1 to 3. The UE 702 in FIG. 7 may be the UE 40 as explained with reference to FIGS. 1 to 3.

In step 721, the base station (BS) 701 transmits in a cell a first indication indicating the number of TRPs (or transmission points) that can be or are being used in the cell, using a signal, physical channel, or message to be received by at least a plurality of UEs in an idle state or mode. In step 722, the base station 701 transmits a second indication that is used in combination with the first indication to indicate time domain locations that are used for SSB transmission within an SSB burst set. The second indication is information that is common to a plurality of TRPs. The UE 702 receives the first indication and the second indication.

The second indication may be transmitted on a different signal, physical channel, or message than that on which the first indication is transmitted. For example, the first indication may be transmitted on a signal or physical channel included in an SSB, while the second indication may be transmitted on SIB1. Alternatively, the second indication may be transmitted on the same signal, physical channel, or message as the first indication. For example, both the first and second indications may be transmitted on SIB1.

As described in the second example embodiment, the multiple candidate time domain locations within an SSB burst set may be divided into multiple subsets, and each subset may be associated with a given number of TRP(s). The given number may be one or more. In this case, the second indication may be common to multiple TRPs and indicate one or more candidate time domain locations used for SSB transmission within each subset.

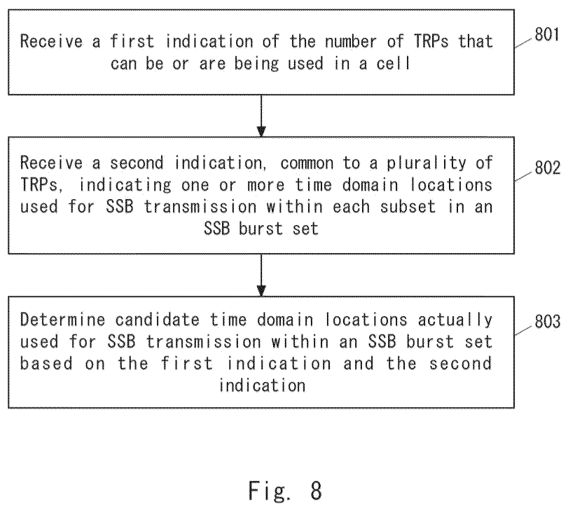

FIG. 8 shows an example of the operation of a UE (e.g., UE 40 or 702). In step 801, the UE receives a first indication of the number of TRPs that can be or are being used in a cell. In step 802, the UE receives a second indication, common to a plurality of TRPs, indicating one or more time domain locations used for SSB transmission within each subset in an SSB burst set. In step 803, the UE determines candidate time domain locations actually used for SSB transmission within an SSB burst set based on the first indication and the second indication.

The second indication may include a first bitmap and a second bitmap. The first bitmap indicates which one or more of the multiple groups within each subset are in use in an SSB burst set. In other words, the first bitmap indicates which one or more of the groups within each subset are active. In contrast, the second bitmap indicates at which one or more of the time domain locations within the active group the SSBs are being transmitted. The first and second bitmaps may be included in the “ssb-PositionsInBurst” field in SIB1. The names of the first and second bitmaps can be “groupPresenceCommon” and “inOneGroupCommon” respectively. The value 0 in the first bitmap may indicate that the SSB transmission based on the second bitmap is not performed in the corresponding group. In this case, the value 1 in the first bitmap indicates that one or more SSBs are transmitted according to the second bitmap in the corresponding group. The value 0 in the second bitmap may indicate that the corresponding SSB is not transmitted. In this case, the value 1 in the second bitmap indicates that the corresponding SSB is transmitted.

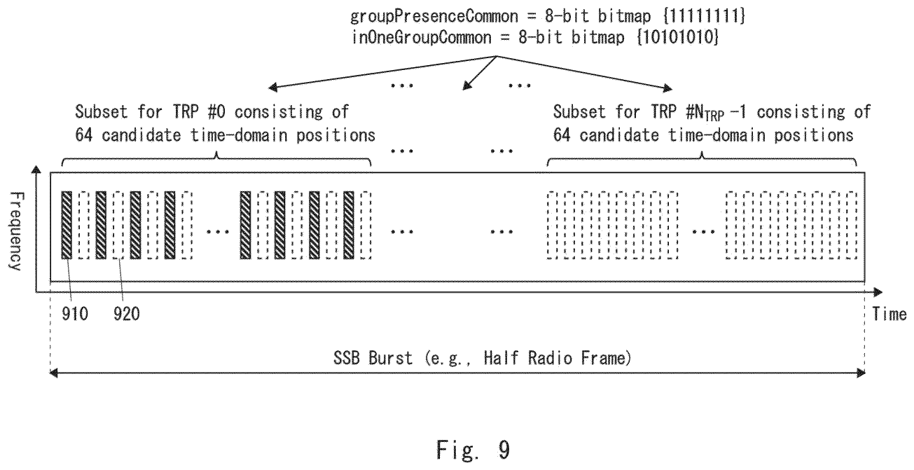

FIG. 9 shows a specific example of the second indication, which is used to show the actual used time domain locations within an SSB burst set. In the example in FIG. 9, the candidate time domain locations within a single SSB burst set are divided into N_{TRP} subsets, with each subset consisting of 64 candidate time domain locations. The second indication is used to show which one or more of the 64 candidate time domain locations within each subset are being used. In the example in FIG. 9, the “group PresenceCommon” and “inOneGroupCommon” fields are each an 8-bit bitmap. Eight time domain locations make up a group. In the example in FIG. 9, the “groupPresenceCommon” field indicates that all the eight groups are active, and the “inOneGroupCommon” field indicates that the first, third, fifth, and seventh time domain locations in each group are active. At the candidate time domain locations 910, which are shaded in FIG. 9, SSBs are being transmitted. On the other hand, SSBs are not transmitted at candidate time domain locations 920, which are not shaded in FIG. 9.

The signaling described in this example embodiment helps to reduce the amount of information or the number of bits required to indicate to UEs the candidate time domain locations in which SSBs are actually being transmitted. For example, suppose that the maximum number of TRPs in a cell is 32, and the SSB burst set is divided into 32 subsets accordingly. Further assume that each subset consists of 64 candidate time domain locations, as shown in FIG. 9. If two 8-bit bitmaps similar to the second indication shown in FIG. 9 were prepared for each of the 32 subsets, a total data size of 512 bits would be required to indicate the active candidate time domain locations within the SSB burst set. In contrast, in this example embodiment, the first indication only needs to be a 5-bit string. In addition, the second indication only needs to be a 16-bit string that is the sum of the two 8-bit bitmaps shown in FIG. 9. Therefore, the total bit length of the first and second indications is only 21 bits.

As described above, each subset within an SSB burst set may be associated with two or more TRPs. In other words, SSBs can be transmitted from two or more TRPs at multiple candidate time domain locations within a single subset. In this case, the base station may transmit a third indication in the cell indicating the number of TRPs with which each subset is associated. The first indication, the second indication, and the third indication may be transmitted with different signals, physical channels, or messages. Alternatively, two or all of the first, second, and third indications may be transmitted using the same signal, physical channel, or message. For example, the first indication may be transmitted via a signal or physical channel within an SSB, while the second and third indications may be transmitted via SIB1. Alternatively, the first, second, and third indications may all be transmitted via SIB1.

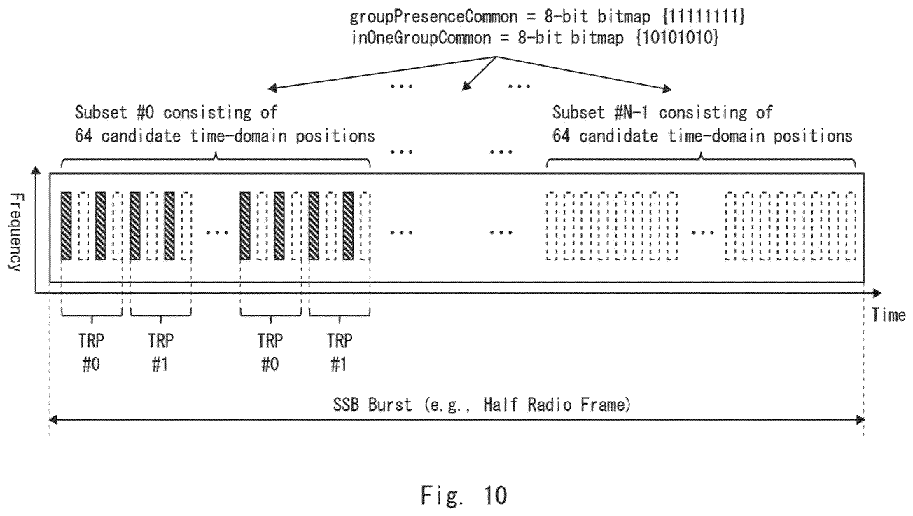

FIG. 10 shows a variation of the example shown in FIG. 9. In the example shown in FIG. 10, a subset is associated with two TRPs. Accordingly, the total number N of subsets within a single SSB burst set is equal to half the maximum number of TRPs in a cell, i.e., N_{TRP}/2.

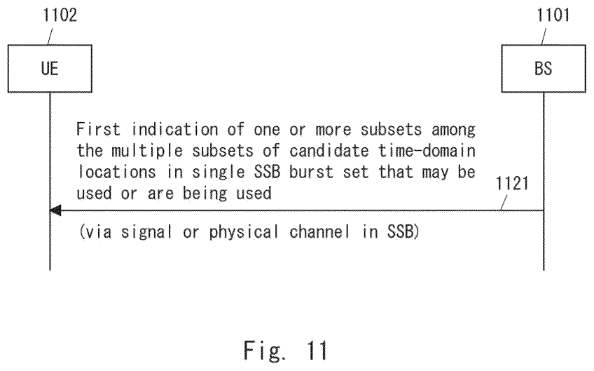

It should be noted that in some implementations, it is not necessary for the UE to know the number of TRPs that can be or are being used within a cell. As can be understood from the example explained with reference to FIG. 10, in some implementations, it is sufficient for the UE to know the number of subsets that can be or are being used in a cell. Thus, the transmission of the first indication by the base station (step 421 in FIG. 4 or step 721 in FIG. 7) may be modified as shown in FIG. 11. In step 1121 of FIG. 11, the base station 1101 transmits, via a signal or physical channel included in an SSB, a first indication indicating the number of one or more subsets that are potentially used or are being used among the multiple subsets of candidate time domain locations within a single SSB burst set. To indicate the active candidate time domain locations within a subset, the base station may transmit a second indication as described with reference to FIGS. 7 to 10. The UE 1102 receives the first indication and may further receive the second indication.

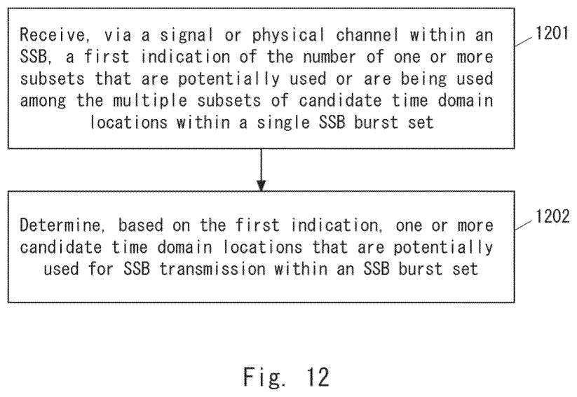

FIG. 12 shows an example of the operation of a UE (e.g., UE 40 or 1102). In step 1201, the UE receives a first indication via a signal or physical channel within an SSB. The first indication indicates the number of one or more subsets that are potentially used or are being used among the multiple subsets of candidate time domain locations within a single SSB burst set. In step 1202, based on the first indication, the UE determines one or more candidate time domain locations that are potentially used for SSB transmission within an SSB burst set. In other words, based on the first indication, the UE determines one or more active subsets for SSB transmission. The UE may also receive the second indication as explained with reference to FIGS. 7 to 10. In this case, the UE may determine one or more active subsets based on the first indication and determine one or more active candidate time domain locations within each active subset based on the second indication.

### Fourth Example Embodiment

An example configuration of a radio communication system in this example embodiment may be the same as the example explained with reference to FIGS. 1 to 3. This example embodiment provides details of the operation of the base station and the UE with respect to the signaling indicating the number of TRPs described in the first example embodiment.

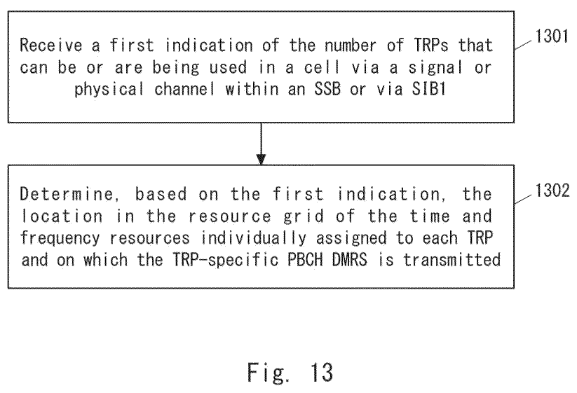

FIG. 13 shows an example of the operation of a UE (e.g., UE 40). In step 1301, the UE receives, via a signal or a physical channel in an SSB, a first indication indicating the number of TRPs (or transmission points) that can be or are being used in a cell. The base station may provide this first indication to the UE using at least the sequence of a synchronization signal transmitted in the SSB, i.e., PSS or SSS. Additionally or alternatively, the base station may provide the first indication to the UE using at least the sequence of a PBCH DMRS transmitted within the SSB. The PBCH DMRS is used by the UE to demodulate PBCH modulation symbols generated from a PBCH payload. Additionally or alternatively, the base station may provide the first indication to the UE using at least the PBCH payload (e.g., MIB).

In step 1302, based on the first indication, the UE determines the location in the resource grid of the time and frequency resources individually assigned to each TRP and on which a TRP-specific PBCH DMRS is transmitted. The location of these time and frequency resources within the resource grid may be referred to as the arrangement, mapping pattern, transmission pattern, or assignment pattern of these time and frequency resources within the resource grid. A resource grid is the time-frequency representation of the radio resources available for transmission. A resource grid is a set of resource elements or resource blocks that are available for transmission, i.e., it consists of multiple subcarriers in the frequency domain and multiple OFDM symbols in the time domain. A resource grid may be characterized or defined by a full or whole carrier bandwidth in the frequency domain and a single subframe in the time domain.

In this example embodiment, the base station controls each of the multiple TRPs in the cell to transmit a TRP-specific PBCH DMRS in a separate first set of time and frequency resources per TRP. The TRP-specific PBCH DMRS is used by UEs to demodulate the same set or one of the different sets of modulation symbols generated from the same PBCH payload or from different PBCH payloads. In other words, the base station transmits DMRS used to demodulate the same set or one of the different sets of modulation symbols generated from the same PBCH payload or from different PBCH payloads, from each of the multiple transmission points in a first set of time and frequency resources specific to each transmission point. The first set of time and frequency resources may be a set of resource elements.

In addition, the base station controls the TRPs in the cell to transmit the same set or the different sets of PBCH modulation symbols in the same second set of time and frequency resources. In other words, the base station transmits the same set or the different sets of PBCH modulation symbols from the multiple transmission points in the same second set of time and frequency resources. The second set of time and frequency resources may be a set of resource elements.

The UE receives the TRP-specific PBCH DMRS in the separate first set of time and frequency resources per TRP. In addition, the UE receives the same set or the different sets of PBCH modulation symbols in the second set of time and frequency resources common to the multiple TRPs.

In some implementations, the UE may estimate an individual channel response between each TRP and the UE based on the reception of the TRP-specific PBCH DMRS, and may demodulate and decode the PBCH payload from one of the different sets of PBCH modulation symbols using the individual channel response. Depending on the location of the UE, the UE may receive SSB transmissions from multiple TRPs simultaneously, but the UE may be able to demodulate the PBCH payload of an SSB received at a higher power.

In other implementations, the UE may estimate an individual channel response between each TRP and the UE based on the reception of the TRP-specific PBCH DMRS, and calculate a composite channel response using multiple individual channel responses between multiple TRPs and the UE. The UE may then demodulate and decode the same PBCH payload from the same set of PBCH modulation symbols using the composite channel response.

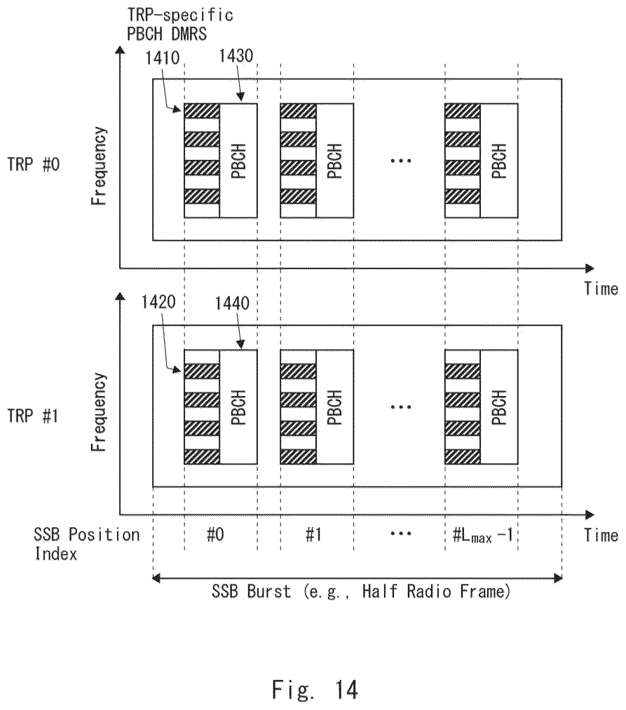

FIG. 14 shows an example of SSB transmission by two TRPs within a single SSB burst set. In the example shown in FIG. 14, the maximum number of candidate time domain locations where each TRP can transmit SSBs within a single SSB burst set is Lₘₐₓ. The number of SSBs actually transmitted by each TRP is configurable and may be less than the maximum. The two TRPs #0 and #1 share the same candidate time domain locations within the SSB burst set, and transmit PBCH 1430 and PBCH 1440 in the same time and frequency resources (resource elements). However, the two TRPs #0 and #1 transmit their respective TRP-specific PBCH DMRSs 1410 and 1420 in different time and frequency resources (resource elements) within each candidate time domain location.

For example, and not as a limitation, Lₘₐₓ can be 64, the same as in the current NR specifications. In addition, the duration of an SSB burst set can be half a radio frame, or 5 ms, the same as in the current NR specifications. Even in this case, in the example in FIG. 14, the two TRPs #0 and #1 can transmit a total of up to 128 SSB beams in a single SSB burst set. In addition, the UE can obtain a measured value of the received power or quality of each of the TRP-specific PBCH DMRSS 1410 and 1420 by measuring different time and frequency resources (resource elements).

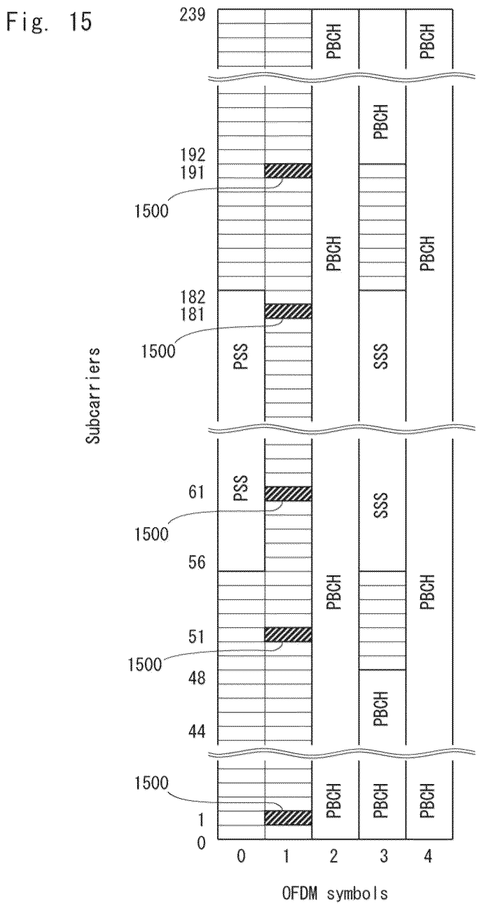

FIG. 15 shows an example of the mapping of the TRP-specific PBCH DMRS within an SSB. In the example shown in FIG. 15, an SSB is extended to span five consecutive OFDM symbols in the time domain. The frequency domain resources occupied by an SSB in FIG. 15 are the same as those of an SSB in the existing NR specifications, i.e., 240 subcarriers or 20 resource blocks. In the example in FIG. 15, the TRP-specific PBCH DMRS of one TRP is mapped to the set of resource elements 1500. The multiple resource elements 1500 are located in the same OFDM symbol #1 in the time domain and are separated by 10 subcarrier intervals in the frequency domain. In other words, in the example in FIG. 15, it is possible to transmit TRP-specific PBCH DMRSs of up to 10 TRPs using the 240 resource elements in OFDM symbol #1. The resource element numbers to which the TRP-specific PBCH DMRS for each TRP is mapped can be expressed by the following formula:

$$Resource element number = TRP ID + k \times {N}_{TRP}$$

where the TRP ID is an integer greater than or equal to 0 and less than N_{TRP}, and N_{TRP} is the maximum number of TRPs in a single cell. In the example in FIG. 15, N_{TRP} is 10.

The base station may change the time and frequency resources (e.g., resource elements) within an SSB over which the TRP-specific PBCH DMRS is mapped, depending on or based on the number of TRPs (or transmission points) that may be used or are being used in the cell. In other words, the base station may change the arrangement or mapping of the TRP-specific PBCH DMRS within an SSB, based on the number of TRPs that can be used or are being used in the cell. Further, in other words, the base station may change the arrangement or mapping of the TRP-specific PBCH DMRS within an SSB depending on or according to the number of TRPs that may transmit or are transmitting simultaneously at a single candidate time domain location within an SSB burst set. Alternatively, the base station may change the arrangement or mapping of the TRP-specific PBCH DMRS within an SSB depending on or according to the number of SSBs or beams that may be transmitted or are being transmitted simultaneously at a single candidate time domain location within an SSB burst set. The UE may assume that the TRP-specific PBCH DMRS arrangement or mapping within an SSB will be changed in this way.

In this case, as explained in the first example embodiment, the base station notifies the UE of the number of TRPs that can be used or are being used in the cell. This allows the UE to determine the arrangement or mapping of the TRP-specific PBCH DMRS. In other words, as explained with reference to FIG. 13, based on the first indication, the UE can determine the location in the resource grid of the time and frequency resources that are individually assigned to each TRP and on which the TRP-specific PBCH DMRS is transmitted.

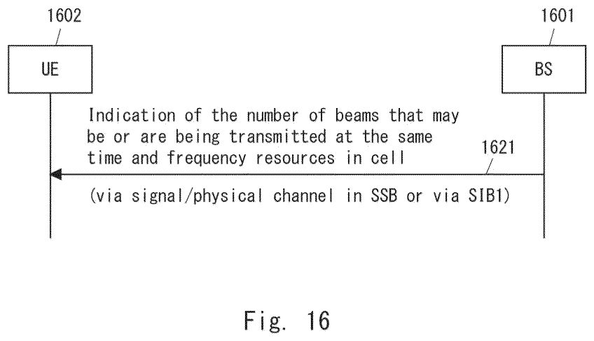

It should be noted that in some implementations, it is not necessary for the UE to know the number of TRPs that can be or are being used within a cell. In some implementations, the arrangement or mapping of the TRP-specific PBCH DMRS within an SSB may be changed depending on the number of SSBs or beams that may be transmitted or are being transmitted simultaneously at the same time and frequency resources in a single candidate time domain location within an SSB burst set. In this case, as shown in step 1621 of FIG. 16, the base station 1601 may notify the UE 1602 of a first indication indicating the number of SSBs or beams that may be transmitted or are being transmitted simultaneously in the same time and frequency resources. The UE 1602 may determine, based on the first indication, the location in the resource grid of the time and frequency resources that are individually assigned to each TRP and on which the TRP-specific PBCH DMRS is transmitted.

### Fifth Example Embodiment

An example configuration of a radio communication system in this example embodiment may be the same as the example explained with reference to FIGS. 1 to 3. This example embodiment provides details of the operation of the base station and the UE with respect to the signaling indicating the number of TRPs described in the first example embodiment.

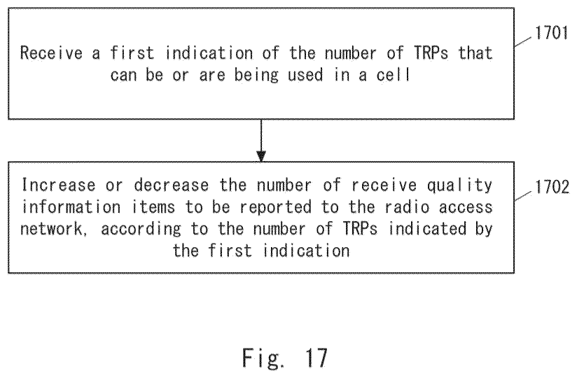

FIG. 17 shows an example of the operation of a UE (e.g., UE 40). In step 1701, the UE receives a first indication indicating the number of TRPs (or transmission points) that can be or are being used in a cell. The base station may provide this first indication to the UE using at least the sequence of a synchronization signal transmitted in the SSB, i.e., PSS or SSS. Additionally or alternatively, the base station may provide the first indication to the UE using at least the sequence of a PBCH DMRS transmitted within the SSB. The PBCH DMRS is used by the UE to demodulate PBCH modulation symbols generated from a PBCH payload. Additionally or alternatively, the base station may provide the first indication to the UE using at least the PBCH payload (e.g., MIB). Additionally or alternatively, the base station may provide the first indication to the UE using at least configuration information within SIB1.

In step 1702, the UE increases or decreases the number of receive quality information items to be reported to the radio access network (e.g., base station) depending on or according to the number of TRPs indicated by the first indication. In other words, the UE determines the number of receive quality information items to be reported to the radio access network based on the number of TRPs indicated by the first indication. More specifically, the UE may increase the number of reported receive quality information items as the number of TRPs increases, and decrease the number of reported receive quality information items as the number of TRPs decreases.

According to the operation described in FIG. 17, the UE can set the appropriate number of reporting items according to the number of TRPs. This can thus reduce the transmission overhead of measurement reporting from the UE to the radio access network (e.g., base station).

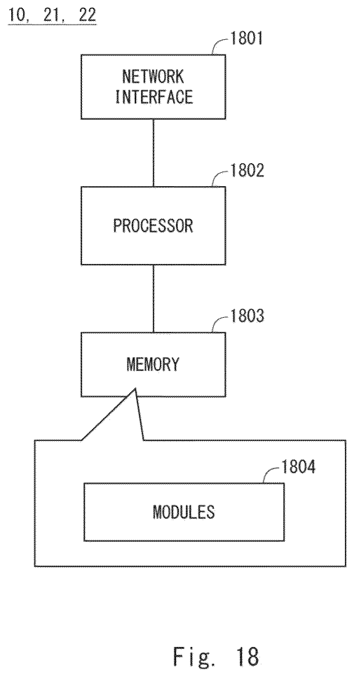

The following describes example configurations of the CU 10, the DUs 21 and 22, the TRPs 31 to 35, and the UE 40 shown in FIG. 1. FIG. 18 shows a block diagram of an example configuration of the CU 10. The configuration of the DUs 21 and 22 may be similar to that shown in FIG. 16. In addition, the configuration of the base stations (e.g., base stations 401, 701, 1101, 1601, etc.) described in the above example embodiments may be similar to the configuration shown in FIG. 18.

Referring to FIG. 18, the CU 10 includes a network interface 1801, a processor 1802, and a memory 1803. The network interface 1801 is used to communicate with network nodes (e.g., DUs, and control plane (CP) nodes and/or user plane (UP) nodes in the core network). The network interface 1801 may include a plurality of interfaces. The network interface 1801 may include, for example, a fiber optic interface for communication between the CU and DUs and a network interface compliant with the IEEE 802.3 series.

The processor 1802 may include a plurality of processors. If the CU 10 is a CU-CP, the processor 1802 performs control plane processing, such as processing related to NGAP, RRC, E1AP, and F1AP signaling. If the CU 10 includes a CU-UP, the processor 1802 performs, for example, NG-U interface termination, F1-U interface termination, and data processing for the SDAP and PDCP layers.

In the case of the DUs 21 and 22, the processor 1802 performs digital baseband signal processing (data plane processing) and control plane processing for wireless communications. For example, the processor 1802 may include a modem processor (e.g., a Digital Signal Processor (DSP)) that performs digital baseband signal processing and a protocol stack processor (e.g., a Central Processing Unit (CPU) or a Micro Processing Unit (MPU)) that performs control plane processing. The digital baseband signal processing may include signal processing for the RLC, MAC, and PHY layers. The control plane processing may include processing of MAC CEs and DCIs. The processor 1802 may include a digital beamformer module for beamforming. The digital beamformer module may include a Multi-Input Multi-Output (MIMO) encoder and precoder.

The memory 1803 is composed of a combination of volatile and non-volatile memory. The volatile memory is, for example, Static Random Access Memory (SRAM), Dynamic RAM (DRAM), or a combination thereof. The non-volatile memory is Mask Read Only Memory (MROM), Electrically Erasable Programmable ROM (EEPROM), flash memory, hard disk drive, or any combination thereof. The memory 1803 may include storage that is remote from the processor 1802. In this case, the processor 1802 may access the memory 1803 through the network interface 1801 or another I/O interface.

The memory 1803 may store one or more software modules (or computer programs) 1804 containing a set of instructions and data for processing by the CU 10 described in the plurality of embodiments described above. In some implementations, the processor 1802 may be configured to read and execute the one or more software modules 1804 from the memory 1803, thereby performing the processing of the CU 10 described in the example embodiments described above.

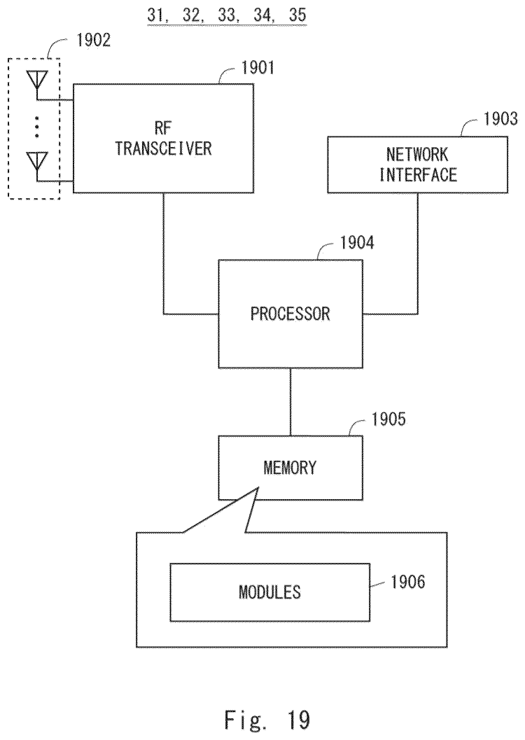

FIG. 19 is a block diagram showing an example configuration of the TRPs 31 to 35. Referring to FIG. 19, each of the TRPs 31 to 35 includes an RF transceiver 1901, a network interface 1903, a processor 1904, and a memory 1905. The RF transceiver 1901 performs analog RF signal processing to communicate with the UEs. The RF transceiver 1901 may include a plurality of transceivers. The RF transceiver 1901 is coupled to an antenna array 1902 and the processor 1904. The RF transceiver 1901 receives modulated symbol data from the processor 1904, generates a transmission RF signal, and supplies the transmission RF signal to the antenna array 1902. The RF transceiver 1901 generates a baseband reception signal based on a reception RF signal received by the antenna array 1902 and supplies the baseband reception signal to the processor 1904. The RF transceiver 1901 may include an analog beamformer circuit for beamforming. The analog beamformer circuit includes, for example, a plurality of phase shifters and a plurality of power amplifiers.

The network interface 1903 is used to communicate with network nodes (e.g., DUs, other TRPs). The network interface 1903 may include a plurality of interfaces. The network interface 1903 may include, for example, a fiber optic interface for communication between a DU and a TRP (and between TRPs) and a network interface compliant with the IEEE 802.3 series.

The processor 1904 may include one or more processors. The processor 1904 may include a DFE and a controller. The DFE provides low PHY layer signal processing and digital radio signal processing.

The memory 1905 is composed of a combination of volatile and non-volatile memory. The volatile memory is, for example, SRAM, DRAM, or a combination thereof. The non-volatile memory is MROM, EEPROM, flash memory, hard disk drive, or any combination thereof. The memory 1905 may include storage that is remote from the processor 1904. In this case, the processor 1904 may access the memory 1905 through the network interface 1903 or an I/O interface not shown.

The memory 1905 may store one or more software modules (or computer programs) 1906 containing a set of instructions and data for performing at least a portion of the processing by the TRPs 31 to 35 described in the example embodiments described above. In some implementations, the processor 1904 may be configured to read and execute the software module 1906 from the memory 1905, thereby performing at least a portion of the processing of the TRPs 31 to 35 described in the example embodiments described above.

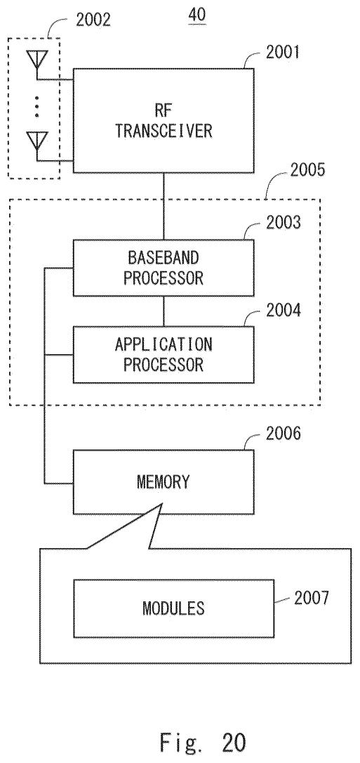

FIG. 20 is a block diagram showing an example configuration of the UE 40. The RF transceiver 2001 performs analog RF signal processing to communicate with the TRPs. The RF transceiver 2001 may include a plurality of transceivers. The analog RF signal processing performed by the RF transceiver 2001 includes frequency up-conversion, frequency down-conversion, and amplification. The RF transceiver 2001 is coupled with an antenna array 2002 and a baseband processor 2003. The RF transceiver 2001 receives modulated symbol data (or OFDM symbol data) from the baseband processor 2003, generates a transmission RF signal, and supplies the transmission RF signal to the antenna array 2002. The RF transceiver 2001 also generates a baseband received signal based on a received RF signal received by the antenna array 2002, and supplies the baseband received signal to the baseband processor 2003. The RF transceiver 2001 may include an analog beamformer circuit for beamforming. The analog beamformer circuit includes, for example, multiple phase shifters and multiple power amplifiers.

The baseband processor 2003 performs digital baseband signal processing (data-plane processing) and control-plane processing for wireless communication. The digital baseband signal processing includes (a) data compression/decompression, (b) data segmentation/concatenation, (c) transmission format (transmission frame) composition/decomposition, (d) channel encoding/decoding, (e) modulation (i.e., symbol mapping)/demodulation, and (f) generation of OFDM symbol data (baseband OFDM signal) using Inverse Fast Fourier Transform (IFFT) and so on. On the other hand, the control-plane processing includes communication management of layer 1 (e.g., transmission power control), layer 2 (e.g., radio resource management, and hybrid automatic repeat request (HARQ) processing), and layer 3 (e.g., signaling related to attach, mobility, and call management).

For example, the digital baseband signal processing performed by the baseband processor 2003 may include signal processing for the SDAP, PDCP, RLC, MAC, and PHY layers. The control plane processing by the baseband processor 2003 may include processing of Non-Access Stratum (NAS) protocols, RRC protocols, MAC CEs, and DCIs.

The baseband processor 2003 may perform MIMO encoding and precoding for beamforming.

The baseband processor 2003 may include a modem processor (e.g., DSP) that performs digital baseband signal processing and a protocol stack processor (e.g., CPU or MPU) that performs control plane processing. In this case, the protocol stack processor that performs control plane processing may be integrated with an application processor 2004 described later.

The application processor 2004 is also referred to as a CPU, MPU, microprocessor, or processor core. The application processor 2004 may include a plurality of processors (a plurality of processor cores). The application processor 2004 executes system software programs (operating system (OS)) and various application programs (e.g., voice call application, web browser, mailer, camera control application, music player application) read from a memory 2006 or other memory not shown, thereby realizing various functions of the UE 40.

In some implementations, as shown by the dashed line (2005) in FIG. 20, the baseband processor 2003 and the application processor 2004 may be integrated on a single chip. In other words, the baseband processor 2003 and the application processor 2004 may be implemented as a single System on Chip (SoC) device 2005. The SoC device may also be referred to as a system large-scale integration (LSI) or chipset.

The memory 2006 is a volatile memory, a non-volatile memory, or a combination thereof. The memory 2006 may include a plurality of physically independent memory devices. The volatile memory is, for example, SRAM, DRAM, or a combination thereof. The non-volatile memory is, for example, MROM, EEPROM, flash memory, or a hard disk drive, or any combination thereof. For example, the memory 2006 may include an external memory device that is accessible by the baseband processor 2003, the application processor 2004, and the SoC 2005. The memory 2006 may include an internal memory device that is integrated into the baseband processor 2003, the application processor 2004, or the SoC 2005. In addition, the memory 2006 may include memory within a Universal Integrated Circuit Card (UICC).

The memory 2006 may store one or more software modules (or computer programs) 2007 that include a set of instructions and data for performing the processing by the radio terminal 3 described in the above example embodiments. In some implementations, the baseband processor 2003 or the application processor 2004 may be configured to read and execute the software modules 2007 from the memory 2006, thereby performing the processing of the UE 40 as described in the example embodiments with reference to the drawings.

The control plane processing and operations performed by the UE 40 described in the above example embodiment can be implemented by elements other than the RF transceiver 2001 and the antenna array 2002, namely at least one of the baseband processor 2003 and the application processor 2004, and the memory 2006 that stores the software modules 2007.

As described using FIGS. 18, 19, and 20, each of the processors in the CU, DUS, TRPs, and UEs of the above example embodiment can execute one or more programs, containing a set of instructions, to cause a computer to perform an algorithm described with reference to the drawings. Each of these programs contains a set of instructions (or software codes) that, when loaded into a computer, causes the computer to perform one or more of the functions described in the example embodiments. Each of these programs may be stored in a non-transitory computer readable medium or a tangible storage medium. By way of example, and not limitation, non-transitory computer readable media or tangible storage media can include a random-access memory (RAM), a read-only memory (ROM), a flash memory, a solid-state drive (SSD) or other memory technologies, CD-ROM, digital versatile disk (DVD), Blu-ray (registered mark) disc or other optical disk storage, magnetic cassettes, magnetic tape, magnetic disk storage or other magnetic storage devices. Each program may be transmitted on a transitory computer readable medium or a communication medium. By way of example, and not limitation, transitory computer readable media or communication media can include electrical, optical, acoustical, or other form of propagated signals.

The example embodiments described above are merely examples of applications of the technical ideas of the inventors. These technical ideas are not limited to the above-described example embodiments, and various modifications may be made thereto.

For example, the whole or part of the example embodiments disclosed above can be described as, but not limited to, the following supplementary notes.

### Supplementary Note 1

A base station comprising:
at least one memory; and
at least one processor coupled to the at least one memory and configured to:
   transmit within a cell, using a signal, physical channel, or message to be received by at least a plurality of radio terminals in an idle mode, a first indication indicating a number of transmission points that can be or are being used in the cell.

### Supplementary Note 2

The base station according to Supplementary Note 1, wherein the signal, physical channel, or message is a signal or physical channel included in a Synchronization Signal (SS)/Physical Broadcast Channel (PBCH) block (SSB).

### Supplementary Note 3

The base station according to Supplementary Note 1 or 2, wherein the at least one processor is configured to transmit the first indication using a sequence of a synchronization signal.

### Supplementary Note 4

The base station according to Supplementary Note 3, wherein the synchronization signal is a Primary Synchronization Signal (PSS) or a Secondary Synchronization Signal (SSS).

### Supplementary Note 5

The base station according to Supplementary Note 1 or 2, wherein the at least one processor is configured to transmit the first indication using a sequence of a demodulation reference signal for demodulating modulation symbols generated from a broadcast channel payload.

### Supplementary Note 6

The base station according to Supplementary Note 5, wherein the demodulation reference signal is a Physical Broadcast Channel (PBCH) Demodulation Reference Signal (DMRS).

### Supplementary Note 7

The base station according to Supplementary Note 1 or 2, wherein the at least one processor is configured to transmit the first indication using a broadcast channel payload.

### Supplementary Note 8

The base station according to Supplementary Note 7, wherein the broadcast channel payload is a Physical Broadcast Channel (PBCH) payload.

### Supplementary Note 9

The base station according to Supplementary Note 1, wherein the signal, physical channel, or message is a System Information Block Type 1 (SIB1).

### Supplementary Note 10

The base station according to any one of Supplementary Notes 1 to 9, wherein
the at least one processor is configured to transmit the first indication via a signal or a physical channel included in a Synchronization Signal (SS)/Physical Broadcast Channel (PBCH) block (SSB), and
the first indication is used by a radio terminal to determine one or more candidate time domain locations that are potentially used for SSB transmission within an SSB burst set.

### Supplementary Note 11

The base station according to any one of Supplementary Notes 1 to 10, wherein the at least one processor is further configured to transmit, within the cell, a second indication that is used in combination with the first indication to indicate time domain locations that are used for SSB transmission within a Synchronization Signal (SS)/Physical Broadcast Channel (PBCH) block (SSB) burst set.

### Supplementary Note 12

The base station according to Supplementary Note 11, wherein
a plurality of candidate time domain locations within the SSB burst set are divided into a plurality of subsets,
each subset is associated with one or more transmission points, and
the second indication is common to a plurality of transmission points and indicates one or more time domain locations that are used for SSB transmission within each subset.

### Supplementary Note 13

The base station according to Supplementary Note 11 or 12, wherein
the first indication is transmitted via a signal or physical channel included in a Synchronization Signal (SS)/Physical Broadcast Channel (PBCH) block (SSB), and
the second indication is transmitted via a System Information Block Type 1 (SIB1).

### Supplementary Note 14

The base station according to Supplementary Note 12, wherein the at least one processor is further configured to transmit a third indication within the cell indicating a number of transmission points with which each subset is associated.

### Supplementary Note 15

The base station according to Supplementary Note 14, wherein
the first indication is transmitted via a signal or physical channel included in a Synchronization Signal (SS)/Physical Broadcast Channel (PBCH) block (SSB), and
the second indication and the third indication are transmitted via a System Information Block Type 1 (SIB1).

### Supplementary Note 16

The base station according to any one of Supplementary Notes 1 to 15, wherein the first indication is used by a radio terminal to determine locations within a resource grid of time and frequency resources that are individually assigned to each transmission point and in which a transmission point-specific demodulation reference signal is transmitted.

### Supplementary Note 17

A method performed by a base station, the method comprising:
transmitting within a cell, using a signal, physical channel, or message to be received by at least a plurality of radio terminals in an idle mode, a first indication indicating a number of transmission points that can be or are being used in the cell.

### Supplementary Note 18

A program for causing a computer to perform a method for a base station, the method comprising:
transmitting within a cell, using a signal, physical channel, or message to be received by at least a plurality of radio terminals in an idle mode, a first indication indicating a number of transmission points that can be or are being used in the cell.

### Supplementary Note 19

A radio terminal comprising:
at least one memory; and
at least one processor coupled to the at least one memory and configured to:
   receive, via a signal, physical channel, or message to be received by at least a plurality of radio terminals in an idle mode, a first indication indicating a number of transmission points that can be or are being used in a cell.

### Supplementary Note 20

The radio terminal according to Supplementary Note 19, wherein the signal, physical channel, or message is a signal or physical channel included in a Synchronization Signal (SS)/Physical Broadcast Channel (PBCH) block (SSB).

### Supplementary Note 21

The radio terminal according to Supplementary Note 19 or 20, wherein the at least one processor is configured to receive the first indication via a sequence of a synchronization signal.

### Supplementary Note 22

The radio terminal according to Supplementary Note 21, wherein the synchronization signal is a Primary Synchronization Signal (PSS) or a Secondary Synchronization Signal (SSS).

### Supplementary Note 23

The radio terminal according to Supplementary Note 19 or 20, wherein the at least one processor is configured to receive the first indication via a sequence of a demodulation reference signal for demodulating modulation symbols generated from a broadcast channel payload.

### Supplementary Note 24

The radio terminal according to Supplementary Note 23, wherein the demodulation reference signal is a Physical Broadcast Channel (PBCH) Demodulation Reference Signal (DMRS).

### Supplementary Note 25

The radio terminal according to Supplementary Note 19 or 20, wherein the at least one processor is configured to receive the first indication via a broadcast channel payload.

### Supplementary Note 26

The radio terminal according to Supplementary Note 25, wherein the broadcast channel payload is a Physical Broadcast Channel (PBCH) payload.

### Supplementary Note 27

The radio terminal according to Supplementary Note 19, wherein the signal, physical channel, or message is a System Information Block Type 1 (SIB1).

### Supplementary Note 28

The radio terminal according to any one of Supplementary Notes 19 to 27, wherein
the at least one processor is configured to receive the first indication via a signal or a physical channel included in a Synchronization Signal (SS)/Physical Broadcast Channel (PBCH) block (SSB), and
the at least one processor is configured to determine, based on the first indication, one or more candidate time domain locations that are potentially used for SSB transmission within an SSB burst set.

### Supplementary Note 29

The radio terminal according to any one of Supplementary Notes 19 to 28, wherein the at least one processor is further configured to receive a second indication that is used in combination with the first indication to indicate time domain locations that are used for SSB transmission within a Synchronization Signal (SS)/Physical Broadcast Channel (PBCH) block (SSB) burst set.

### Supplementary Note 30

The radio terminal according to Supplementary Note 29, wherein
a plurality of candidate time domain locations within the SSB burst set are divided into a plurality of subsets,
each subset is associated with one or more transmission points, and
the second indication is common to a plurality of transmission points and indicates one or more time domain locations that are used for SSB transmission within each subset.

### Supplementary Note 31

The radio terminal according to Supplementary Note 29 or 30, wherein the at least one processor is configured to determine time domain locations actually used for SSB transmission within the SSB burst set based on the first indication and the second indication.

### Supplementary Note 32

The radio terminal according to any one of Supplementary Notes 29 to 31, wherein
the first indication is transmitted via a signal or physical channel included in a Synchronization Signal (SS)/Physical Broadcast Channel (PBCH) block (SSB), and
the second indication is transmitted via a System Information Block Type 1 (SIB1).

### Supplementary Note 33

The radio terminal according to Supplementary Note 30, wherein the at least one processor is further configured to transmit a third indication within the cell indicating a number of transmission points with which each subset is associated.

### Supplementary Note 34

The radio terminal according to Supplementary Note 33, wherein
the first indication is transmitted via a signal or physical channel included in a Synchronization Signal (SS)/Physical Broadcast Channel (PBCH) block (SSB), and
the second indication and the third indication are transmitted via a System Information Block Type 1 (SIB1).

### Supplementary Note 35

The radio terminal according to any one of Supplementary Notes 19 to 34, wherein the at least one processor is configured to determine, based on the first indication, locations within a resource grid of time and frequency resources that are individually assigned to each transmission point and in which a transmission point-specific demodulation reference signal is transmitted.

### Supplementary Note 36

The radio terminal according to any one of Supplementary Notes 19 to 35, wherein the at least one processor is configured to increase or decrease a number of receive quality information items to be reported to a radio access network, depending on the number of transmission points that can be or are being used in the cell indicated by the first indication.

### Supplementary Note 37

A method performed by a radio terminal, the method comprising:
receiving, via a signal, physical channel, or message to be received by at least a plurality of radio terminals in an idle mode, a first indication indicating a number of transmission points that can be or are being used in a cell.

### Supplementary Note 38

A program for causing a computer to perform a method for a radio terminal, the method comprising:
receiving, via a signal, physical channel, or message to be received by at least a plurality of radio terminals in an idle mode, a first indication indicating a number of transmission points that can be or are being used in a cell.

### Supplementary Note 39

A base station comprising:
at least one memory; and
at least one processor coupled to the at least one memory and configured to:
   transmit, via a signal or physical channel within a Synchronization Signal (SS)/Physical Broadcast Channel (PBCH) block (SSB), a first indication indicating a number of one or more subsets of a plurality of subsets of candidate time domain locations within an SSB burst set that are potentially used or are being used.

### Supplementary Note 40

The base station according to Supplementary Note 39, wherein the first indication is used by a radio terminal to determine one or more candidate time domain locations that are potentially used for SSB transmission within the SSB burst set.

### Supplementary Note 41

The base station according to Supplementary Note 39 or 40, wherein each of the plurality of subsets is associated with one or more transmission points.

### Supplementary Note 42

The base station according to any one of Supplementary Notes 39 to 41, wherein the at least one processor is further configured to transmit a second indication indicating one or more time domain locations used for SSB transmission within each subset.

### Supplementary Note 43

The base station according to Supplementary Note 42, wherein the second indication is transmitted via a System Information Block Type 1 (SIB1).

### Supplementary Note 44

A method performed by a base station, the method comprising: transmitting, via a signal or physical channel within a Synchronization Signal (SS)/Physical Broadcast Channel (PBCH) block (SSB), a first indication indicating a number of one or more subsets of a plurality of subsets of candidate time domain locations within an SSB burst set that are potentially used or are being used.

### Supplementary Note 45

A program for causing a computer to perform a method for a base station, the method comprising:
transmitting, via a signal or physical channel within a Synchronization Signal (SS)/Physical Broadcast Channel (PBCH) block (SSB), a first indication indicating a number of one or more subsets of a plurality of subsets of candidate time domain locations within an SSB burst set that are potentially used or are being used.

### Supplementary Note 46

A radio terminal comprising:
at least one memory; and
at least one processor coupled to the at least one memory and configured to:
   receive, via a signal or physical channel within a Synchronization Signal (SS)/Physical Broadcast Channel (PBCH) block (SSB), a first indication indicating a number of one or more subsets of a plurality of subsets of candidate time domain locations within an SSB burst set that are potentially used or are being used.

### Supplementary Note 47

The radio terminal according to Supplementary Note 46, wherein the at least one processor is configured to determine, based on the first indication, one or more candidate time domain locations that are potentially used for SSB transmission within the SSB burst set.

### Supplementary Note 48

The radio terminal according to Supplementary Note 46 or 47, wherein each of the plurality of subsets is associated with one or more transmission points.

### Supplementary Note 49

The radio terminal according to any one of Supplementary Notes 46 to 48, wherein the at least one processor is further configured to receive a second indication indicating one or more time domain locations used for SSB transmission within each subset.

### Supplementary Note 50

The radio terminal according to Supplementary Note 49, wherein the second indication is transmitted via a System Information Block Type 1 (SIB1).

### Supplementary Note 51

The radio terminal according to Supplementary Note 49 or 50, wherein the at least one processor is configured to determine time domain locations actually used for SSB transmission within the SSB burst set based on the first indication and the second indication.

### Supplementary Note 52

A method performed by a radio terminal, the method comprising:
receiving, via a signal or physical channel within a Synchronization Signal (SS)/Physical Broadcast Channel (PBCH) block (SSB), a first indication indicating a number of one or more subsets of a plurality of subsets of candidate time domain locations within an SSB burst set that are potentially used or are being used.

### Supplementary Note 53

A program for causing a computer to perform a method for a radio terminal, the method comprising:
receiving, via a signal or physical channel within a Synchronization Signal (SS)/Physical Broadcast Channel (PBCH) block (SSB), a first indication indicating a number of one or more subsets of a plurality of subsets of candidate time domain locations within an SSB burst set that are potentially used or are being used.

### Supplementary Note 54

A base station comprising:
at least one memory; and
at least one processor coupled to the at least one memory and configured to:
   transmit within a cell, using a signal, physical channel, or message to be received by at least a plurality of radio terminals in an idle mode, a first indication indicating a number of beams that can be transmitted or are being transmitted in same time and frequency resources in the cell.

### Supplementary Note 55

The base station according to Supplementary Note 54, wherein the first indication is used by a radio terminal to determine locations within a resource grid of time and frequency resources that are individually assigned to each transmission point and in which a transmission point-specific demodulation reference signal is transmitted.

### Supplementary Note 56

The base station according to Supplementary Note 54 or 55, wherein the signal, physical channel, or message is a signal or physical channel included in a Synchronization Signal (SS)/Physical Broadcast Channel (PBCH) block (SSB).

### Supplementary Note 57

The base station according to Supplementary Note 56, wherein the at least one processor is configured to transmit the first indication using a sequence of a Primary Synchronization Signal (PSS) or Secondary Synchronization Signal (SSS) transmitted within the SSB.

### Supplementary Note 58

The base station according to Supplementary Note 56, wherein the at least one processor is configured to transmit the first indication using a sequence of a Physical Broadcast Channel (PBCH) Demodulation Reference Signal (DMRS) transmitted within the SSB.

### Supplementary Note 59

The base station according to Supplementary Note 56, wherein the at least one processor is configured to transmit the first indication using a sequence of a Physical Broadcast Channel (PBCH) payload transmitted within the SSB.

### Supplementary Note 60

A method performed by a base station, the method comprising:
transmitting within a cell, using a signal, physical channel, or message to be received by at least a plurality of radio terminals in an idle mode, a first indication indicating a number of beams that can be transmitted or are being transmitted in same time and frequency resources in the cell.

### Supplementary Note 61

A program for causing a computer to perform a method for a base station, the method comprising:
transmitting within a cell, using a signal, physical channel, or message to be received by at least a plurality of radio terminals in an idle mode, a first indication indicating a number of beams that can be transmitted or are being transmitted in same time and frequency resources in the cell.

### Supplementary Note 62

A radio terminal comprising:
at least one memory; and
at least one processor coupled to the at least one memory and configured to:
   receive, via a signal, physical channel, or message to be received by at least a plurality of radio terminals in an idle mode, a first indication indicating a number of beams that can be transmitted or are being transmitted in same time and frequency resources in a cell.

### Supplementary Note 63

The radio terminal according to Supplementary Note 62, wherein the at least one processor is configured to determine, based on the first indication, locations within a resource grid of time and frequency resources that are individually assigned to each transmission point and in which a transmission point-specific demodulation reference signal is transmitted.

### Supplementary Note 64

The radio terminal according to Supplementary Note 62 or 63, wherein the signal, physical channel, or message is a signal or physical channel included in a Synchronization Signal (SS)/Physical Broadcast Channel (PBCH) block (SSB).

### Supplementary Note 65

The radio terminal according to Supplementary Note 64, wherein the at least one processor is configured to receive the first indication via a sequence of a Primary Synchronization Signal (PSS) or Secondary Synchronization Signal (SSS) transmitted within the SSB.

### Supplementary Note 66

The radio terminal according to Supplementary Note 64, wherein the at least one processor is configured to receive the first indication via a sequence of a Physical Broadcast Channel (PBCH) Demodulation Reference Signal (DMRS) transmitted within the SSB.

### Supplementary Note 67

The radio terminal according to Supplementary Note 64, wherein the at least one processor is configured to receive the first indication via a Physical Broadcast Channel (PBCH) payload transmitted within the SSB.

### Supplementary Note 68

A method performed by a radio terminal, the method comprising:
receiving, via a signal, physical channel, or message to be received by at least a plurality of radio terminals in an idle mode, a first indication indicating a number of beams that can be transmitted or are being transmitted in same time and frequency resources in a cell.

### Supplementary Note 69

A program for causing a computer to perform a method for a radio terminal, the method comprising:
receiving, via a signal, physical channel, or message to be received by at least a plurality of radio terminals in an idle mode, a first indication indicating a number of beams that can be transmitted or are being transmitted in same time and frequency resources in a cell.

This application is based upon and claims the benefit of priority from Japanese Patent Application No. 2022-143673, filed on Sep. 9, 2022, the disclosure of which is incorporated herein in its entirety by reference.

### REFERENCE SIGNS LIST

10 CU
21, 22 DU
31, 32, 33, 34, 35 TRP
40 UE
51, 52, 53 Cell
1802 Processor
1803 Memory
1904 Processor
1905 Memory
2003 Baseband processor
2004 Application processor
2006 Memory

What is claimed is:

1-16. (canceled)

17. A method performed by a base station, the method comprising:
transmitting within a cell, using a signal, physical channel, or message to be received by at least a plurality of radio terminals in an idle mode, a first indication indicating a number of transmission points that can be or are being used in the cell.

18. (canceled)

19. A radio terminal comprising:
at least one memory; and
at least one processor coupled to the at least one memory and configured to:
receive, via a signal, physical channel, or message to be received by at least a plurality of radio terminals in an idle mode, a first indication indicating a number of transmission points that can be or are being used in a cell.

20-36. (canceled)

37. A method performed by a radio terminal, the method comprising:
receiving, via a signal, physical channel, or message to be received by at least a plurality of radio terminals in an idle mode, a first indication indicating a number of transmission points that can be or are being used in a cell.

38-69. (canceled)

70. The method according to claim 37, wherein the signal, physical channel, or message is a signal or physical channel included in a Synchronization Signal (SS)/Physical Broadcast Channel (PBCH) block (SSB).

71. The method according to claim 37, wherein the receiving comprises receiving the first indication via a sequence of a synchronization signal.

72. The method according to claim 71, wherein the synchronization signal is a Primary Synchronization Signal (PSS) or a Secondary Synchronization Signal (SSS).

73. The method according to claim 37, wherein the receiving comprises receiving the first indication via a sequence of a demodulation reference signal for demodulating modulation symbols generated from a broadcast channel payload.

74. The method according to claim 73, wherein the demodulation reference signal is a Physical Broadcast Channel (PBCH) Demodulation Reference Signal (DMRS).

75. The method according to claim 37, wherein the receiving comprises receiving the first indication via a broadcast channel payload.

76. The method according to claim 75, wherein the broadcast channel payload is a Physical Broadcast Channel (PBCH) payload.

77. The method according to claim 37, wherein the signal, physical channel, or message is a System Information Block Type 1 (SIB1).

78. The method according to claim 37, wherein
the receiving comprises receiving the first indication via a signal or a physical channel included in a Synchronization Signal (SS)/Physical Broadcast Channel (PBCH) block (SSB), and
the method further comprises determining, based on the first indication, one or more candidate time domain locations that are potentially used for SSB transmission within an SSB burst set.

79. The method according to claim 37, further comprising receiving a second indication that is used in combination with the first indication to indicate time domain locations that are used for SSB transmission within a Synchronization Signal (SS)/Physical Broadcast Channel (PBCH) block (SSB) burst set.

80. The method according to claim 79, wherein
a plurality of candidate time domain locations within the SSB burst set are divided into a plurality of subsets,
each subset is associated with one or more transmission points, and
the second indication is common to a plurality of transmission points and indicates one or more time domain locations that are used for SSB transmission within each subset.

81. The method according to claim 79, further comprising determining time domain locations actually used for SSB transmission within the SSB burst set based on the first indication and the second indication.

82. The method according to claim 79, wherein
the first indication is transmitted via a signal or physical channel included in a Synchronization Signal (SS)/Physical Broadcast Channel (PBCH) block (SSB), and
the second indication is transmitted via a System Information Block Type 1 (SIB1).

83. The method according to claim 80, further comprising receiving a third indication within the cell indicating a number of transmission points with which each subset is associated.

84. The method according to claim 83, wherein
the first indication is transmitted via a signal or physical channel included in a Synchronization Signal (SS)/Physical Broadcast Channel (PBCH) block (SSB), and
the second indication and the third indication are transmitted via a System Information Block Type 1 (SIB1).

85. The method according to claim 37, further comprising determining, based on the first indication, locations within a resource grid of time and frequency resources that are individually assigned to each transmission point and in which a transmission point-specific demodulation reference signal is transmitted.

86. The method according to claim 37, further comprising increasing or decreasing a number of receive quality information items to be reported to a radio access network, depending on the number of transmission points that can be or are being used in the cell indicated by the first indication.
